(19) United States
(12) Patent Application Publication
(10) Pub. No.: US 2007/0174196 A1
(43) Pub. Date: Jul. 26, 2007

(54) System and method for verifying authenticity

(76) Inventors: Christoph Becker, Plankstadt (DE); Benjamin Ringl, Leimen (DE)

Correspondence Address: FISH & RICHARDSON, P.C., PO BOX 1022, MINNEAPOLIS, MN, 55440-1022, US

(21) Appl. No.: 11/339,878

(22) Filed: Jan. 26, 2006

(51) Int. Cl. H04L 9/00

(52) U.S. Cl. 705/50

(57) ABSTRACT

The disclosure provides systems and methods for helping authenticate products and registrations of such products. One method for providing a product comprises providing a product associated with a first identifier, such as a serial number, to a customer. The method further includes providing a registration form with a second identifier to the customer. This registration form is associated with the product and the second identifier comprises an encrypted form of the first identifier. One method for verifying a product registration comprises receiving a registration form from a customer, with the registration form including a first identifier and a second identifier. Normally, the second identifier comprises an encrypted value. A decrypted value of the second identifier is then compared to the first identifier. The registration form may then be verified if the decrypted value and the first identifier are substantially similar.

### TECHNICAL FIELD

This disclosure relates to data processing and, more particularly, to a system and method for automatically verifying receipt or registration of goods, services, or documents.

### BACKGROUND

In different purchasing scenarios, customers buy products (or certain services) for which a warranty, refund, or other registration process is offered (or required). For example, manufacturers of short-life-cycle products may want to capture accurate product, warranty, or rebate information. Accordingly, these example manufacturers may use applications or clerks to collect, store, and access electronic information about their installed customer base. In these cases, the customer normally has to complete a predefined form for processing by the product's manufacturer or a third party data processor. This form is often paper-based or electronic. For example, the paper form may be a postcard pre-addressed to the manufacturer. The electronic form may be implemented in an email, email attachment or in a network-based form, which may be downloaded from or filled out on a website or portal. The customer often has to enter the serial number on the form to prove the actual receipt of the example product.

### SUMMARY

The disclosure provides systems and methods for helping authenticate products and registrations of such products. One method for providing an authentic product comprises providing a product associated with a first identifier, such as a serial number, to a customer. The method further includes providing a registration form with a second identifier to the customer. This registration form is associated with the product and the second identifier comprises an encrypted form of the first identifier. Accordingly, subsequent processors of the form may be able to authenticate the product using these two identifiers.

For example, one method for verifying a product registration comprises receiving a registration form from a customer, with the registration form including a first identifier and a second identifier. Normally, the second identifier comprises an encrypted value. The decrypted value of the second identifier is then compared to the first identifier. The registration form may then be verified if the decrypted value and the first identifier are substantially similar, are identical, or otherwise suitably match.

The details of these and other aspects and embodiments of the disclosure are set forth in the accompanying drawings and the description below. For example, each of the foregoing—as well as other disclosed—example methods and techniques may be computer implementable. Moreover, some or all of these aspects may be further included in respective systems and software for verifying or otherwise authenticating products and registrations of such products. In another example, these techniques may be used to verify or otherwise authenticate a document such as a contract, purchase order, receipt, and such. In this example, the document may include or be associated with a receipt confirmation that comprises an encrypted identifier of the document (such as the PO number). In a further example, these techniques may be implemented or provided using Radio Frequency Identification (RFID) tags, thereby helping prevent fraudulent use of RFID tags with products. Certain features, objects, and advantages of the various embodiments will be apparent from the description, drawings, and the claims.

### DESCRIPTION OF DRAWINGS

FIG. 1 illustrates an example system for helping authenticate products and registrations of such products in accordance with one embodiment of the present disclosure;

FIG. 2 illustrates an example application implementing certain techniques and components in accordance with one embodiment of the present disclosure;

FIGS. 3A-B illustrate example physical and electronic registration forms described in FIG. 1;

FIGS. 4A-B illustrate example methods for registering a product, in accordance with one embodiment of the present disclosure;

FIGS. 5A-D illustrate example methods for verifying a product registration, potentially implemented by components similar to those described in FIGS. 1 or 2, in accordance with one embodiment of the present disclosure;

FIG. 6 illustrates an example method for authenticating a product using RFID tags in accordance with one embodiment of the present disclosure; and

FIG. 7 illustrates an example method for authenticating a product using an online service in accordance with one embodiment of the present disclosure.

### DETAILED DESCRIPTION

The disclosure provides systems and methods for helping authenticate products or documents and registrations of such products or documents. For example, various systems, networks, or sales/service channels may implement methods that automatically authenticate or otherwise verify one or more receipt confirmation documents, warranty registration, rebate request, or other registration forms 150 of any suitable kind. In this way, the authenticated receipt document may help a manufacturer to ensure that the customers receive products from the original source of the brand. In addition the customer may be interested in making sure that the product comes from a legitimate (or legal) source to potentially avoid physical or financial harm by inferior, fake, or generic products. This verification may also be used by the customer to assert the authenticity of the product if the manufacturer requests or offers a confirmation of authenticity after having received the authenticated receipt confirmation. For example, using this verification process, the manufacturer may be able to show that the customer (perhaps unwittingly) received or used a fake, thereby relieving the manufacturer of potential damages. In another example, the manufacturer may offer a free or pay service that allows a particular customer or other entity to verify the authenticity as desired, potentially raising sales, brand recognition, and such.

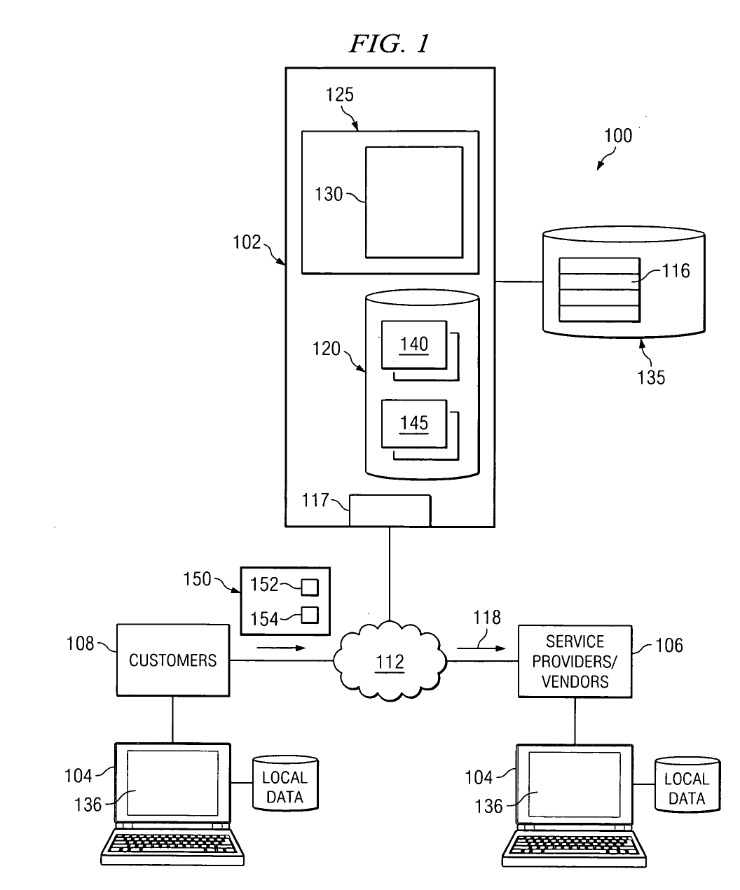

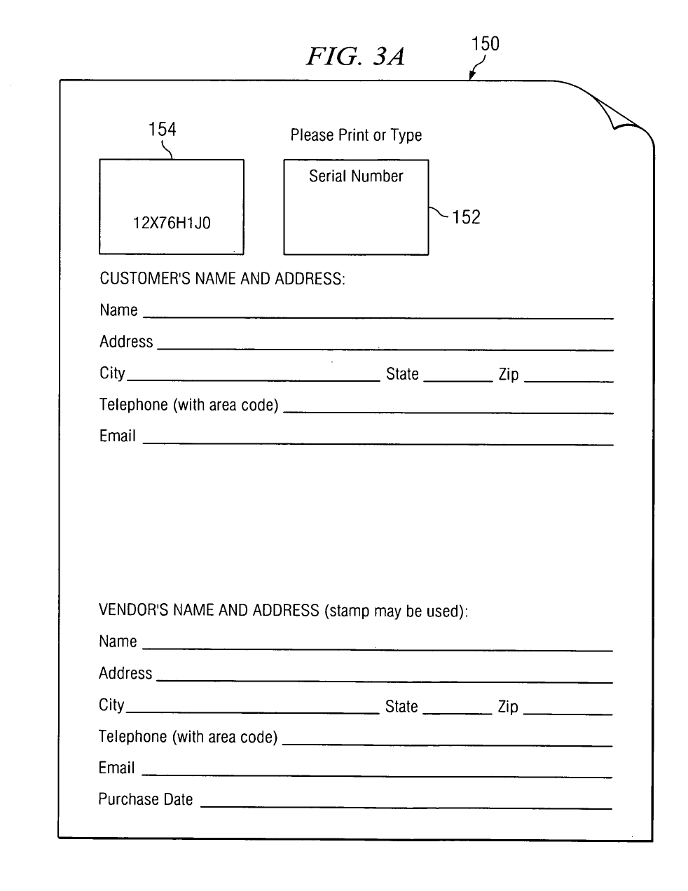

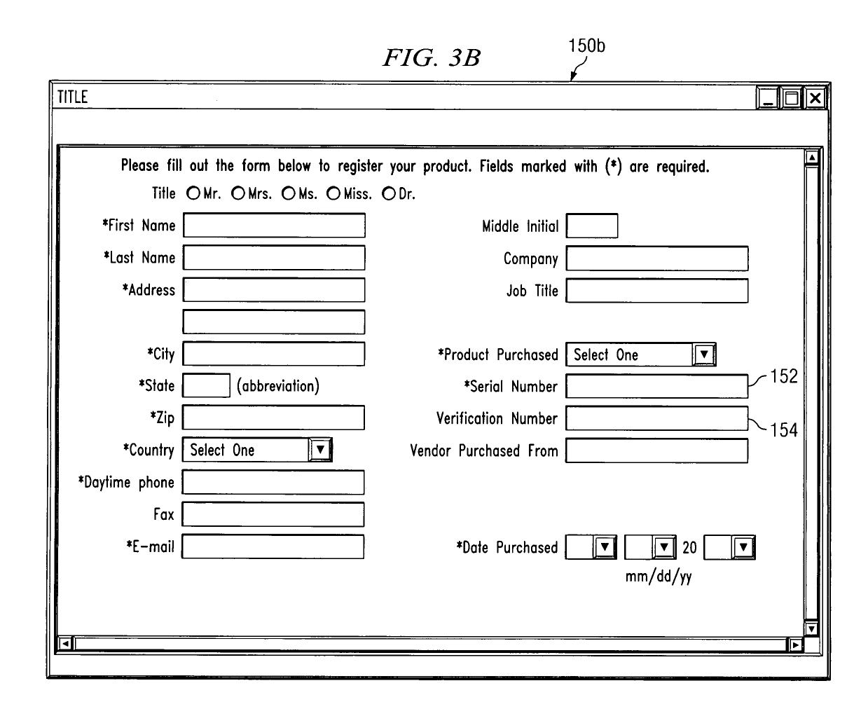

FIG. 1 illustrates an example system 100, part of which is often implemented within an enterprise, for automatically verifying receipt of goods, services, or documents in accordance with one embodiment of the present disclosure. These goods or other objects may be marked with a unique identifier (e.g. serial number, bar code, product key). In certain cases, this identifier marks it as a unique object, but the receipt of the document or good cannot be proven with sufficient reliability to the originator merely by returning the unique identifier code 152 with the registration form 150. Accordingly, this identifier may be encrypted to generate a second identifier 154 that is then preprinted, embedded in a form 150, or otherwise provided along with the product. For example, the product (such as the good, service, or document) may be associated with registration form 150 in any suitable manner, including via a receipt, order confirmation, enclosed rebate forms, identified websites, and such. In other words, this form 150 may be a physical form 150a, such as that represented in FIG. 3A, or an electronic form 150b, such as that illustrated in FIG. 3B. In the first example, the vendor 106 or the product manufacturer may preprint. or otherwise embed the encrypted identifier in the document 150a, while requiring the customer 108 to manually add (such as print or type) the serial number from the product. In the second example, the web page may request the user (such as customer 108) to enter the encrypted value and the serial number in required fields on the web form 150b. Indeed, while described as an actual form, many of these techniques may be used to verbally verify the product or its registration over the phone, in person, and so forth.

In yet another example, the encrypted value may be transmitted or provided using RFID tags, thereby helping prevent fraudulent use of RFID tags with products. More specifically, the individual product codes of the boxes/packing units could be encrypted on the tag. In this example, medication may be shipped or otherwise provided with secured RFID tags. If the medication and the associated RFID tag are not from a legitimate source, then system 100 (such as a pharmacist, doctor, or hospital) may identify or determine this by reading the encrypted keys using RFID technology, scanning the individual codes from the boxes/packing units, and comparing the decrypted values against the product codes. Moreover, the recipient may even further verify the codes via an online check against the manufacturer's data base. If the code on the box does not match that of the tag, then potential fraud can be detected.

In any of these or other similar ways, system 100 allows an appropriate (or authenticated) party—such as the product manufacturer or the product recipient—to compare the encrypted serial number 154 with the serial number 152 provided by the purchasing customer to help ensure that the product or the registration is legitimate. Accordingly, this encryption/decryption may use or implement any suitable encryption algorithm including asymmetric, symmetric, hashing, or others. For example, the algorithm may use an encryption key 118 that is vendor-specific, product model specific, and/or at any other appropriate level of granularity.

In one embodiment, the manufacturer uses a secured encryption key to generate the second identifier for the registration form 150 associated with the product, which is then supplied to vendor 106. For example, the manufacturer may print the forms, package each form with the product, and bulk ship the products to one or more vendors 106. In another case, the manufacturer may instead supply an encryption key 118 and a registration form template 140 to vendor 106, which then generates and provides the registration form 150 to the purchasing customer 108. This encryption key 118 may be communicated to vendor 106 over a secure channel, whether physical or electronic, that is not legitimately available to others. In certain cases, the encryption key may be supplied to each of a plurality of vendors 106 with or without the knowledge of the other vendors 106.

In yet another embodiment, the serial number (or other identifier) may be encrypted using asymmetric keys (or public/private key pair). In asymmetric key encryption, the vendor 106 uses the manufacturer's published public key to encrypt the serial number. This helps prevent transmission, exploring, or theft of the private key on network 112. Asymmetric key encryption generally provides for the capability of encrypting an identifier using a public key that can normally only be decrypted by someone possessing a private key associated with the public key. The private key is normally generated using a one-way function. Using this one-way function, it is relatively easy to compute a result given some initial input values. But it is difficult to determine the original values starting with the result. In mathematical terms, given a value x, computing f(x) is relatively easy. But, given the result f(x), computing x is very difficult. For example, the one-way function used in the RSA algorithm is a multiplication of prime numbers. Public-key cryptography uses two large primes to build a private key, and the product of the primes to build a public key. A simplified example of the RSA algorithm is described as follows:

### Key Generation

By selecting two primes, P=11 and Q=23, the RSA algorithm is used to generate the numbers N, E, and D in the following manner:
N=P×Q=11×23=253
PHI=(P−1)(Q−1)=220
The public exponent E is calculated so that the greater common divisor of E and PHI is 1. In other words, E is relatively prime with PHI. For this example:
E=3
In the RSA algorithm, N and E are used as the public keys. The private key D is the inverse of E modulo PHI. By using an extended Euclidian algorithm, the example private key is determined as D=147.

### Encryption

To encrypt data, for example a number M=4, the following procedure is used to form an encrypted identifier C:
C=MˆE mod N=4ˆmod 253=64
Thus, the example encrypted identifier is 64.

### Decryption

The encrypted identifier can be decrypted to form a decrypted value M from the encrypted identifier C using the following procedure:
M=CˆD mode N=64ˆ147 mode 253=4
thereby recovering the original identifier data. Although the above example used small prime numbers for illustrative purposes, in actual practice the prime numbers selected for public key/private key cryptography are very large numbers, for example 128-bit or 256-bit prime numbers.

Returning to the figure, system 100 is typically a distributed client/server system that spans one or more networks such as 112. In such embodiments, data may be communicated or stored in an encrypted format using any standard or proprietary encryption algorithm. But system 100 may be in a dedicated enterprise environment—across a local area network or subnet—or any other suitable environment without departing from the scope of this disclosure. For example, some components, such as server 102, may be implemented by a manufacturer, a third party data (or rebate) processor for this and/or other manufacturers, a warranty service, and others. Turning to the illustrated embodiment, system 100 includes or is communicably coupled with server 102, one or more clients 104 with vendors 106 or customers 108, and network 112. Generally, vendor 106 may be any local or remote business or other entity operable to provide goods, services, consulting, or other similar offerings that may benefit customers 108 in some way. Often, these vendors 106 may sell products created by a third party manufacturer, such as one implementing or managing example server 102.

Server 102 comprises an electronic computing device operable to receive, transmit, process and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server.

As illustrated (but not required), server 102 is communicably coupled with a relatively remote repository 135 over a portion of network 112. Repository 135 is any intra-enterprise, inter-enterprise, regional, nationwide, or substantially national electronic storage facility, data processing center, or archive that allows for one or a plurality of registration processors—such as the manufacturer or rebate processor—to dynamically store serial numbers 116, which may include any unique identifier of a good, service, or other offering. Each serial number 116 includes some form of the unique identifier and, perhaps, other related data including foreign keys, product names, descriptions, customer IDs, service status, and such. Accordingly, the manufacturer, warranty service provider, rebate processor, or other suitable party can verify that the serial number has not previously been serviced, registered, activated, and such. Repository 135 may be a central database communicably coupled with one or more servers 102 and clients 104 via a virtual private network (VPN), SSH (Secure Shell) tunnel, or other secure network connection. Repository 135 may be physically or logically located at any appropriate location including in one of the example enterprises or off-shore, so long as it remains operable to store information associated with system 100 and communicate such data to server 102 or at least a subset of plurality of clients 104.

As a possible supplement to or replacement of repository 135, illustrated server 102 includes local memory 120. Memory 120 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 includes registration form templates 140 and encryption/decryption key repository 145. But memory 120 may also include any other appropriate data such as VPN applications or services, firewall policies, a security or access log, print or other reporting files, HTML files or templates, data classes or object interfaces, related or unrelated software applications or sub-systems, and others.

Registration form templates 140 include any parameters, variables, algorithms, instructions, rules, files, links, or other data for allowing this or third party entities, such as vendors 106, to generate registration forms for the associated product and/or manufacturer. As described above, the registration form may be used for warranty registration, product activation, purchase order generation, rebate or refund processing, and many other purposes. For example, each template 140 may be tailored for different vendors 106 based on rebate status, warranty offers, or other contractual or sales features. In some embodiments, registration form templates 140 (or pointers thereto) may be stored in one or more tables in a relational database described in terms of SQL statements or scripts. In another embodiment, registration form templates 140 may be formatted, stored, or defined as various data structures in text files, extensible Markup Language (XML) documents, Virtual Storage Access Method (VSAM) files, flat files, Btrieve files, comma-separated-value (CSV) files, internal variables, or one or more libraries. In short, registration form templates 140 may comprise one table or file or a plurality of tables or files stored on one computer or across a plurality of computers in any appropriate format. Indeed, some or all of registration form templates 140 may be local or remote without departing from the scope of this disclosure and store any type of appropriate data. Moreover, registration form templates 140 may be bundled and/or transmitted in a different format, such as a Adobe Interactive Form, than it was stored in.

Encryption/decryption key repository 145 is any physical or logical storage capable of storing a plurality of encryption keys 118 and associated decryption keys. As described above, in certain cases these encryption keys 118 may be transmitted (often over secure channels) to third parties, such as illustrated vendor 106, for subsequent processing of serial numbers for registration forms 150. As with registration form templates 140, these keys 118 may be stored in suitable format including SQL, text files, XML documents, VSAM files, flat files, Btrieve files, CSV files, internal variables, or one or more libraries. Indeed, these encryption and decryption keys may themselves be stored in an encrypted repository 145. These keys may be vendor-based, product-based, model-based, or others. Moreover, each associated encryption/decryption key pair may have an expiration date that is a fixed time frame (say six months), the length of the rebate, the expected shelf life of the product, and such.

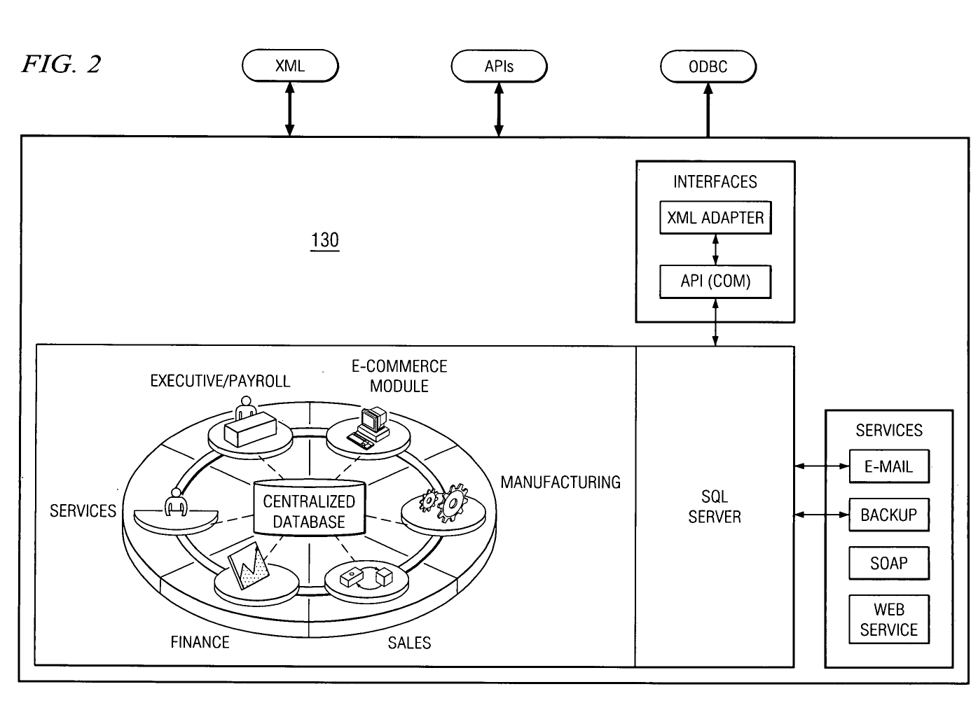

Server 102 also includes processor 125. Processor 125 executes instructions and manipulates data to perform the operations of server 102 such as, for example, a central processing unit (CPU), a blade, an application specific integrated circuit (ASIC), or a field-programmable gate array (FPGA). Although FIG. 2 illustrates a single processor 125 in server 102, multiple processors 125 may be used according to particular needs and reference to processor 125 is meant to include multiple processors 125 where applicable. In the illustrated embodiment, processor 125 executes application 130.

At a high level, application 130 is any application, program, module, process, or other software that helps verify the authenticity of a particular product, service, or document (such as a registration form) or implements some portion of the authentication processes. More specifically, application 130 may offer warranty, refund, or other registration capabilities. For example, application 130 may allow the user or business to i) manage the entire warranty and claims process, from return materials authorization (RMA) to receipt and inspection; and ii) coordinate with third-party logistics providers to help ensure timely customer credits and avoid unnecessary goodwill allowances. This capability may further support business processes such as warranty initiation and establishment, service provider authorization, verification of warranty entitlement and installed base information, claims adjudication between an OEM and a service provider, and warranty recovery from suppliers. In certain cases, system 100 may implement a composite application 130, as described below in FIG. 2. Regardless of the particular implementation, “software” may include software, firmware, wired or programmed hardware, or any combination thereof as appropriate. Indeed, application 130 may be written or described in any appropriate computer language including C, C++, Java, J#, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 130 is illustrated in FIG. 2 as including various sub-modules, application 130 may include numerous other sub-modules or may instead be a single multi-tasked module that implements the various features and functionality through various objects, methods, or other processes. Further, while illustrated as internal to server 102, one or more processes associated with application 130 may be stored, referenced, or executed remotely. For example, a portion of application 130 may be a web service that is remotely called, while another portion of application 130 may be an interface object bundled for processing at remote client 104. Moreover, application 130 may be a child or sub-module of another software module or enterprise application (not illustrated) without departing from the scope of this disclosure. Indeed, application 130 may be a hosted solution that allows multiple parties (such as the manufacturer, vendor 106, and customer 108) in different portions of the process to perform the respective processing.

More specifically, as illustrated in FIG. 2, application 130 may be a composite application, or an application built on other applications, that includes an object access layer (OAL) and a service layer. In this example, application 130 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 130 may run on a heterogeneous IT platform. In doing so, composite application may be cross-functional in that it may drive business processes across different applications, technologies, and organizations. Accordingly, composite application 130 may drive end-to-end business processes across heterogeneous systems or sub-systems. Application 130 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 130, it may instead be a standalone or (relatively) simple software program. Regardless, application 130 may also perform processing automatically, which may indicate that the appropriate processing is substantially performed by at least one component of system 100. It should be understood that automatically further contemplates any suitable administrator or other user interaction with application 130 or other components of system 100 without departing from the scope of this disclosure.

Returning to FIG. 1, server 102 may also include interface 117 for communicating with other computer systems, such as clients 104, over network 112 in a client-server or other distributed environment. In certain embodiments, server 102 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 102 and at least one client 104. For example, server 102 may be communicably coupled to repository 135 through one sub-net while communicably coupled to a particular client 104 through another. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and authenticated vendors 106 or customers 108, via certain local or remote clients 104.

Client 104 is any computing device operable to connect or communicate with server 102 or network 112 using any communication link. At a high level, each client 104 includes or executes at least GUI 134 and comprises an electronic computing device operable to receive, transmit, process and store any appropriate data associated with system 100. It will be understood that there may be any number of clients 104 communicably coupled to server 102. Further, “client 104” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. As used in this disclosure, client 104 is intended to encompass a personal computer, touch screen terminal, workstation, network computer, kiosk, wireless data port, smart phone, personal data assistant (PDA), one or more processors within these or other devices, or any other suitable processing device. For example, client 104 may be a PDA operable to wirelessly connect with an external or unsecured network. In another example, client 104 may comprise a laptop that includes an input device, such as a keypad, touch screen, mouse, or other device that can accept information, and an output device that conveys information associated with the operation of server 102 or clients 104, including digital data, visual information, or GUI 134. Both the input device and output device may include fixed or removable storage media such as a magnetic computer disk, CD-ROM, or other suitable media to both receive input from and provide output to users of clients 104 through the display, namely the client portion of GUI or application interface 134.

GUI 134 comprises a graphical user interface operable to allow the user of client 104 to interface with at least a portion of system 100 for any suitable purpose, such as viewing application or other transaction data. Generally, GUI 134 provides the particular user with an efficient and user-friendly presentation of data provided by or communicated within system 100. GUI 134 may comprise a plurality of customizable frames or views having interactive fields, pull-down lists, and buttons operated by the user. GUI 134 may also present a plurality of portals or dashboards. For example, GUI 134 may display a secure webpage that allows users (such as customers 108) to i) request and monitor rebate statuses; or ii) register for warranty, upgrades, or notices. It should be understood that the term graphical user interface may be used in the singular or in the plural to describe one or more graphical user interfaces and each of the displays of a particular graphical user interface. Indeed, reference to GUI 134 may indicate a reference to the front-end or a component of application 130, as well as the particular interface accessible via client 104, as appropriate, without departing from the scope of this disclosure. Therefore, GUI 134 contemplates any graphical user interface, such as a generic web browser or touch screen, that processes information in system 100 and efficiently presents the results to the user. Server 102 can accept data from client 104 via the web browser (e.g., Microsoft Internet Explorer or Netscape Navigator) and return the appropriate HTML or XML responses to the browser using network 112.

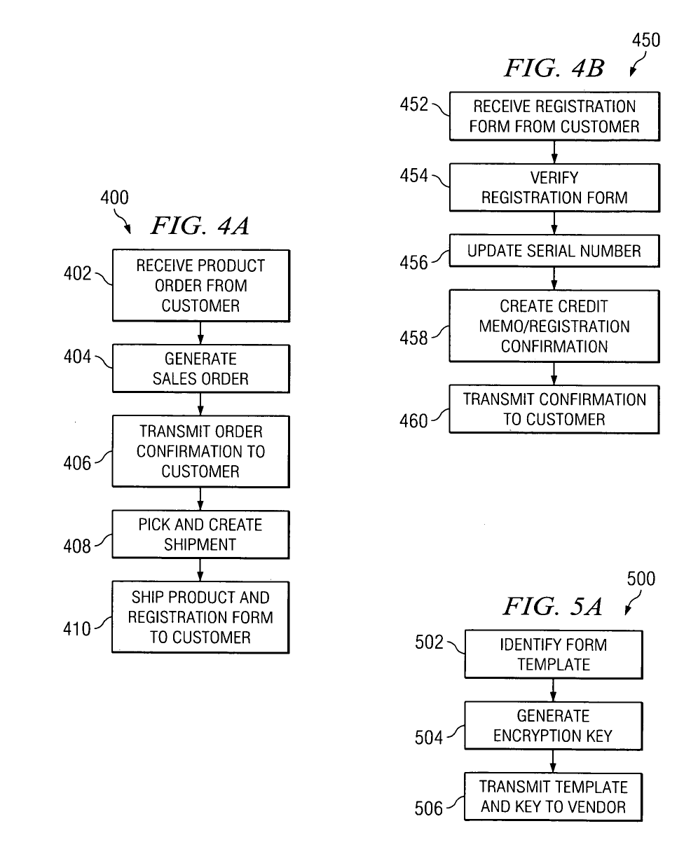

FIGS. 4A-B illustrate example methods (400 and 450 respectively) for providing and registering a product in accordance with one embodiment of the present disclosure. At a high level, method 400 includes an example vendor 106 processing an order for a product from a customer 108 and method 450 includes an example manufacturer processing a registration form 150 previously provided along with the sold product. The following description focuses on the operation of application 130 in performing methods 400 and 450. But system 100 contemplates using any appropriate combination and arrangement of logical elements implementing some or all of the described functionality.

More specifically, method 400 begins at step 402, where a product order is received from a customer 108. While described herein that this order is received and processed by vendor 106, the order may also be directly through the manufacturer, a service provider, or any other suitable entity. Moreover, this order may be received using any appropriate technique including over the phone, in person, over network 112, email, regular mail, and such. Indeed, while described as occurring remotely between vendor 106 and customer 108, this process may instead occur in a store without the described shipping processing. Once the order is received, vendor 106 generates a sales order at step 404. Part of the order processing may include identifying any registration forms 150 that should accompany the order product. For example, vendor 106 may enclose a warranty registration form 150, a rebate request form 150, and so forth. Next, vendor 106 may transmit an order confirmation to the customer at step 406, again using any suitable communication channel. Vendor 106 then, at step 408, picks the product and prepares the shipment. Once suitably prepared, vendor 106 ships the ordered product and any forms 150 to the customer 108. Of course, as described above, the vendor 106 may instead provide a receipt or pick list that provides the encrypted identifier, thereby allowing customer 108 to subsequently enter this information onto a downloaded, printed, or online form 150, as well as verbally provide this information

Method 450, generally describing the processing of at least one of the supplied or referenced registration forms 150, begins at step 452 when the manufacturer (or other form processor) receives the registration form 150 from customer 108. This receipt can occur over any suitable channel including network 112, mail, phone, and others such that the customer 108 is able to provide the serial number (or other identifier) of the product and the encrypted serial number to allow for subsequent verification. At step 454, the manufacturer verifies the registration form 150. This verification may include verifying the serial number, verifying the address is correct, ensuring that required information is complete, and so forth. In the event that certain information is missing, invalid, or incomplete, the manufacturer may transmit such a deficiency to the customer 108. If the registration form 150 is substantially or sufficiently verified, then application 130 may automatically update the serial number repository 135 at step 456 to help ensure that multiple registrations of the product do not occur or to stored useful information such as customer contact and so forth. Application 130 may also automatically generate a confirmation of the registration at step 458 and communicate, whether physically or electronically, this confirmation to the appropriate entity or customer 108.

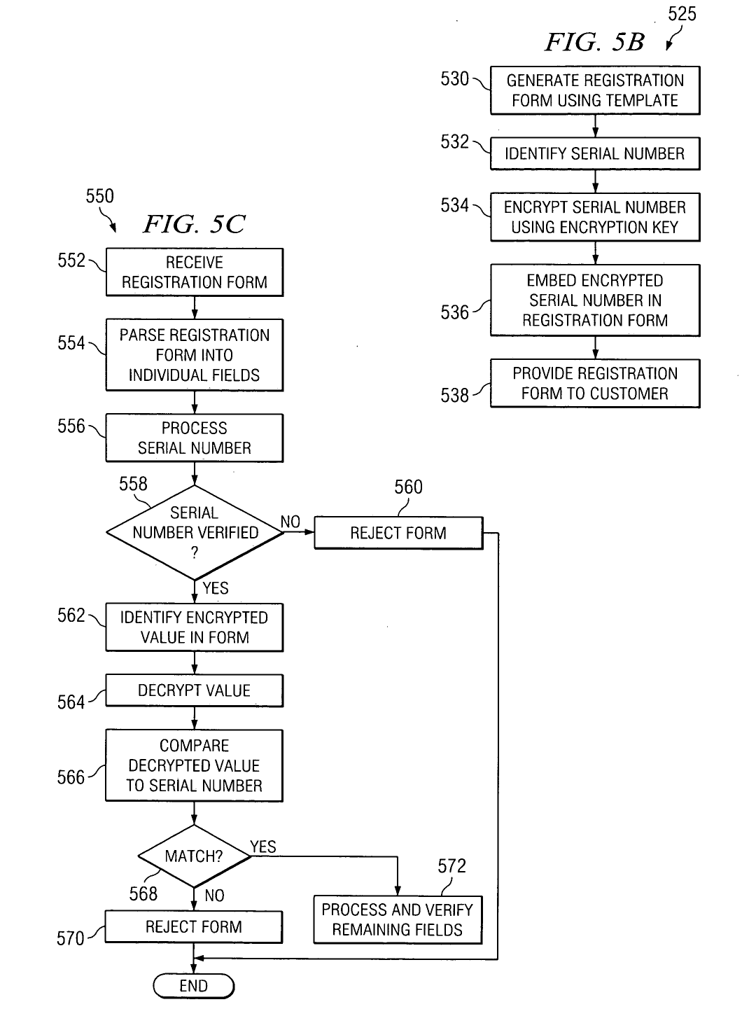

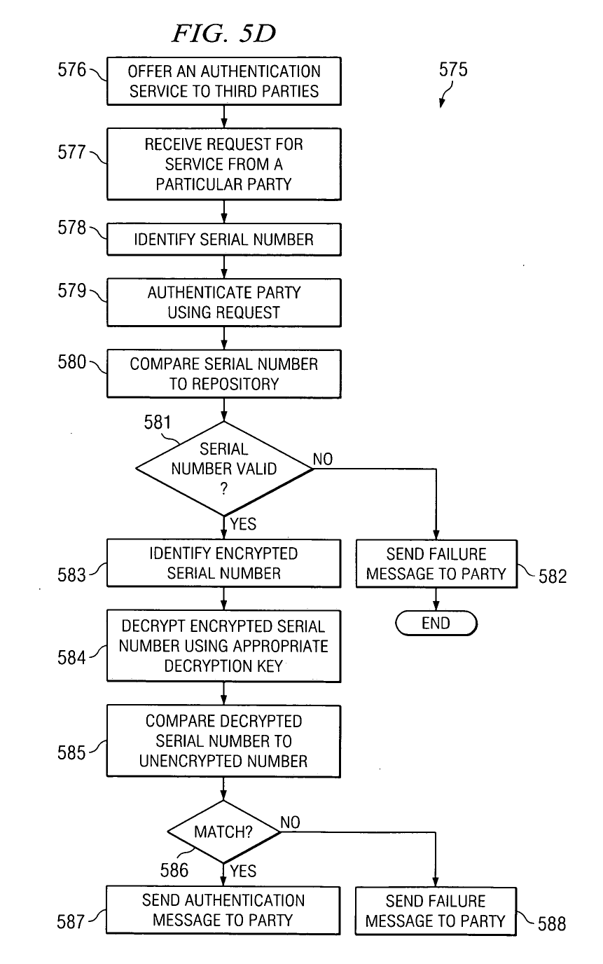

FIGS. 5A-D illustrate example methods (500, 525, 550, and 575 respectively) for verifying a product registration in accordance with one embodiment of the present disclosure. Generally, method 500 describes the communication of the secure registration form template 140 to the vendor 106, method 525 illustrates the generation of the registration form 150 by the particular example vendor 106, and method 550 describes the verification of the completed registration form 150 by the manufacturer. It will be understood that the illustrated implementation by the vendor 106 or the manufacturer are for example purposes only. For example, the manufacturer and the vendor 106 may represent different departments within the same business. In another example, the registration form processing may be implemented by a third party data processor hired by the manufacturer.

Returning to the illustrated embodiment, method 500 begins at step 502, where application 130 identifies the appropriate registration form template 140. As described earlier, this template identification may be based on the particular vendor, the product or model, and such. At step 504, application 130 generates the appropriate encryption key. This generation encompasses application 130 selecting or otherwise identifying a suitable preexisting encryption key from key repository 145. Then, at step 506, the manufacturer transmits the registration form template 140 and encryption key to the particular vendor 106. It will be understood that this transmission may occur in serial or in parallel and across one or multiple channels. For example, application 130 may transmit the registration form templates 140 via a bulk email to a plurality of vendors 106, while allowing each vendor 106 to securely retrieve the appropriate key using a VPN, SSH, sftp, and such. In another example, the manufacturer may send physical registration form templates 140 via a shipment or a truck along with or separate from the associated products. In another example, the manufacturer may bundle a plurality of encryption keys for transmission to one vendor 106, which may then select the appropriate key using any criteria.

FIG. 5B illustrates method 525, which begins at step 530. In this step, the vendor 106 generates a registration form 150 using the template 140. Next, at step 532, the application 130 (or some other component or user of vendor 106) identifies the serial number (or other unique identifier) of a particular product, often at the time of sale. Application 130 then encrypts this identified serial number using the appropriate encryption key at step 534. Next, application 130 embeds this encrypted value 154 into the form 150 at step 536. For example, the form 150 may be based on the Adobe Interactive Form template 140 with the encrypted serial number 154 embedded in the form 150. In another example, application 130 may instead print the series of number, letters, or other symbols or characters that represent the encrypted serial number 154. This secured registration form 150 may then be provided to the customer 108 at step 538.

Method 550, shown in FIG. 5C, generally provides an example technique for verifying that the product being registered, activated, or otherwise noticed is legitimate. This method begins at step 552, where the manufacturer receives—either physically or electronically—the ostensibly completed registration form 150. If electronically, application 130 may parse the information into individual fields for easier or more efficient processing at step 554. For example, application 130 may first process the serial number 116 at step 556. This processing may include ensuring that it is a valid serial number, that it has not been previously registered (perhaps using serial number repository 135), and other suitable processing. If no errors or duplicates are found, then application 130 may then authenticate at least the serial number 116.

If the serial number 116 is verified at decisional step 558, then application 130 may then confirm that the secured registration form 150 matches the provided serial number 152. Otherwise, the manufacturer may reject the form at step 560 and communicate the failure to the customer 108. To determine the match, application 130 may first identify the appropriate decryption key from key repository 145 based on any suitable criteria, such as vendor 106, product, and so forth. Next, application 130 identifies the appropriate encrypted value 154 on registration form 150 at step 562 and decrypts the encrypted value that is embedded in the form 150, printed on the form 150, or otherwise associated with the registration at step 564. Once the value has been determined, then application 130 compares this value to the provided serial number 152 at step 566. If they do not match at decisional step 568, then application 130 may reject the registration at step 570 and communicate the failure to the customer 108. Otherwise, application 130 (or some other user or component) may then process the remaining fields on the form 150 at step 572 to help complete the registration.

FIG. 5D illustrates an example method 575 for managing an authentication service for third parties, including vendors 106 and customers 108. This method may be implemented by the manufacturer—as described—or by a hired agent or entity. Illustrated method 575 begins at step 576, when the example manufacturer invokes, executes, or otherwise initiates the authentication service. Such service may be an online service—such as a web form or web service capable of being called by other web sites or applications—or a telephone service that allows others to call in for authentication. This authentication processing may be relatively automatic using application 130 or users as appropriate. At step 577, the manufacturer receives a request for authentication from any particular third party. The manufacturer then identifies a serial number at step 578. This identification may be based on the request, receiving the number via a form or over the phone, or using any other suitable technique.

Using this identified serial number, the manufacturer may occasionally authenticate the requesting party at 579. For example, if the serial number is associated with a confidential product or only one vendor or recipient, then the manufacturer may verify that the requestor is a secure party, thereby potentially reducing fraud. At step 580, the manufacturer compares the identified serial number to the serial number repository 135 to ensure that the serial number has not previously been authenticated, the manufacture or delivery date is out of a particular range, or if the serial number is associated with a product known to be stolen, lost, or otherwise problematic. If the serial number is not valid at decisional step 581, then a “failure” message is sent to the requesting party at step 582 over any communications channel. Otherwise, the manufacturer identifies the encrypted serial number at step 583. Again, this identification may be based on the request, receiving the number via a form or over the phone, or using any other suitable technique. At step 584, the manufacturer decrypts the encrypted number using any appropriate decryption key.

The decrypted identifier is then compared with the unencrypted identifier, such as the serial number or bar code on the box, to determine a match at step 585. If the identifiers are a match, as shown at decisional step 586, then the product may be determined or identified authentic at step 587. Otherwise, the product or shipment may be considered illegitimate or questionable at step 588. Appropriate messages indicating this status may then be sent to the particular party.

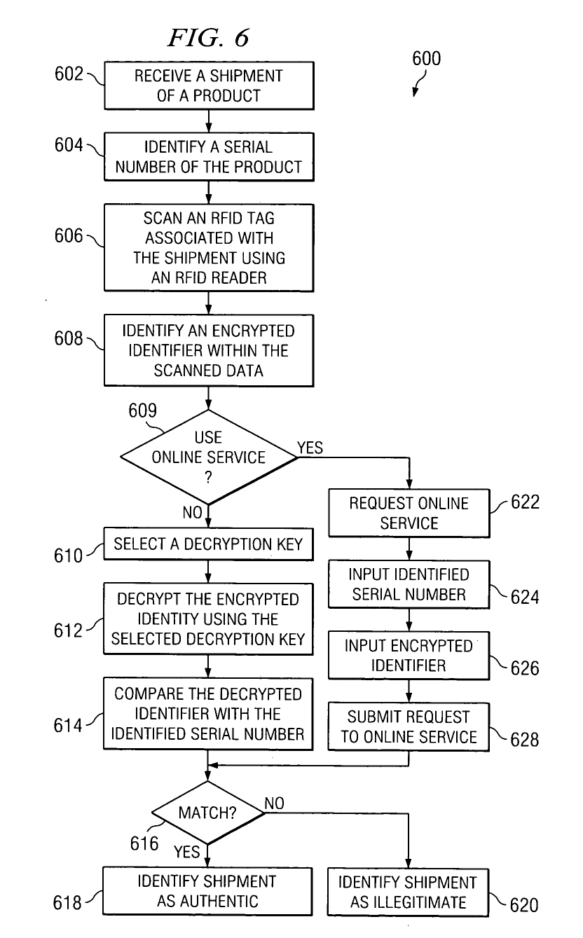

FIG. 6 illustrates an example method 600 for authenticating a product using RFID tags in accordance with one embodiment of the present disclosure. This example method 600 is described in terms of software at least partially resident on an RFID reader capable of reading or otherwise scanning RFID tags. For example, application 130 may be communicably coupled with an agent—resident on the reader—operable to perform the identification of an encrypted serial number or other identifier. In another example, the reader is further capable of decrypting the identifier and then communicating this identifier to application 130 for further processing. As used here, RFID generally encompasses any wireless (or partially wireless) communication that allows for remote retrieval of information associated with a particular commodity, product, component, or other item. In RFID environments, each suitable item is tagged with an RFID tag that includes and (actively or passively) transmits one or more pieces of information including, for example, a unique encrypted identifier. These pieces of information are requested or retrieved by the RFID reader. Typical RFID readers are either small handheld devices that operate in a limited RFID space or are stationary devices located at, for example, doors, gates, and other non-mobile or fixed sites. In many circumstances, RFID technology allows the two devices (the tag and reader) to communicate with one another while not maintaining a line-of-sight in various weather conditions.

Turning to the illustrated embodiment, example method 600 begins at step 602, where a particular party or entity receives a shipment of a product. At step 604, the party identifies a serial number (or other substantially unique identifier) associated with the product. For example, the party may use an RFID reader that includes a scanner that can read bar codes on product boxes. In another example, an employee of the party may read and input the serial number using GUI 134. Next, at step 606, an RFID reader (or other similar device) scans an RFID tag associated with a shipment. While described in terms of one product, this RFID tag may be associated with a shipment of multiple products, boxes, and such. In this case, the RFID tag may include a relatively large amount of data, including a number of encrypted serial numbers, which may be used to verify one or more of the respective items. Once the scanned data is retrieved, an encrypted identified is extracted from the data at step 608. In the forgoing example, a number of identifiers may be extracted and subsequently compared with the unencrypted identifier to determine a match.

Application 130, or a user thereof, may select to use an online service at decisional step 609 such as that described in example method 575. As above, such a service may be an online service—such as a web form (as illustrated for example in FIG. 3B) or web service capable of being called by other web sites or application 130—or a telephone service that allows the user to call in for authentication. At step 622, application 130 (or the user) requests the authentication service. The identified serial number and the encrypted identifier are then input to the service at steps 624 and 626, respectively. Using this information, authentication is then requested at step 628, whereupon the processing proceeds to step 616.

Once the encrypted identifier is determined and if a decryption key is known or identifiable/retrievable, then application 130 selects an appropriate decryption key at step 610 and decrypts at least one of the extracted encrypted identifiers using the selected decryption key at step 612. The decrypted identifier is then compared with the unencrypted identifier, such as the serial number or bar code on the box, to determine a match at step 614. If the identifiers are a match, as shown at decisional step 616, then the product may be determined or identified authentic at step 618. Otherwise, the product or shipment may be considered illegitimate or questionable at step 620. In this instance, the shipment may be returned to the manufacturer (or vendor as appropriate), an investigation may be requested, or any other suitable processing may occur.

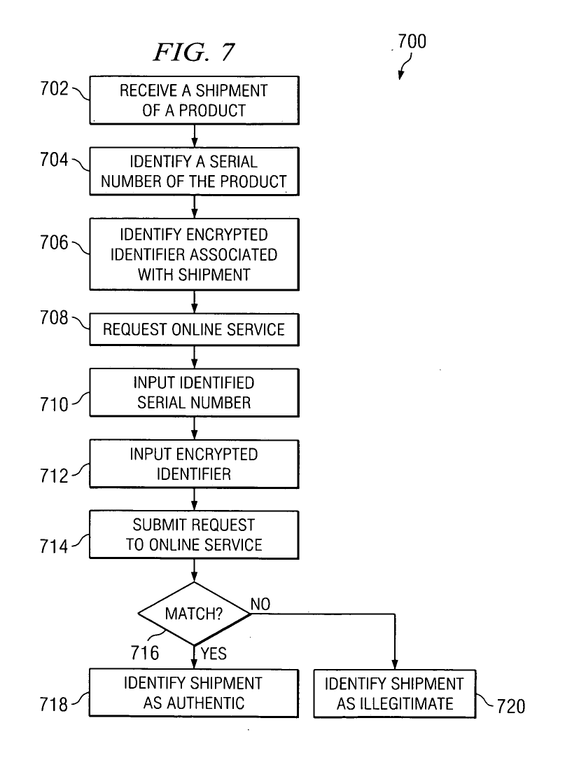

FIG. 7 illustrates an example method 700 for authenticating a product using an online service in accordance with one embodiment of the present disclosure. In this way, the customer 108 may not have to handle decryption procedures and decryption keys. The manufacturer may maintain control such that customer 108 may need no or reduced special tools or software. Example method 700 begins at step 702, where a particular party or entity receives a shipment of a product. At step 704, the party identifies a serial number (or other substantially unique identifier) associated with the product. At step 706, consumer 108 identifies the encrypted identifier 154 associated with the shipment. In this case, the encrypted identifier may be on document 150 (such as a packing slip, registration form, or receipt) or on the shipping box, apart from the product box. The customer 108 may then try to use an authentication service, such as that described in method 575, to ensure that the product is valid, safe, or otherwise authentic. As above, such a service may be an online service—such as a web form (as illustrated for example in FIG. 3B) or web service capable of being called by other web sites or application 130—or a telephone service that allows the user to call in for authentication. At step 708, the customer 108 requests the authentication service. The identified serial number and the encrypted identifier are then input to the service at steps 710 and 712, respectively Using this information, authentication is then requested at step 714. If the identifiers are a match, as shown at decisional step 716, then the product may be determined or identified authentic at step 718. Otherwise, the product or shipment may be considered illegitimate or questionable at step 720. In this instance, the shipment may be returned to the manufacturer (or vendor as appropriate), an investigation may be requested, or any other suitable processing may occur.

The preceding flowcharts and accompanying description illustrate exemplary methods 400, 450, 500, 525, 550, 575, 600, and 700. System 100 contemplates using or implementing any suitable technique for performing these and other tasks. It will be understood that these methods are for illustration purposes only and that the described or similar techniques may be performed at any appropriate time, including concurrently, individually, or in combination. For example, the manufacturer may first generate an encryption key for a particular product model and rebate program. Then, when the products are shipped to a particular first vendor, the manufacturer may then transmit the encryption key to the first vendor. The manufacturer may then determine that a second vendor does not have the capability of generating registration forms 150, so it then generates the registration forms for communication to the second vendor. The manufacturer may then determine that a third vendor is an online vendor, so it then provides the encrypted serial numbers to the third vendor for inclusion in a registration website. In addition, many of the steps in this flowchart may take place simultaneously and/or in different orders than as shown. Moreover, system 100 may use methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. For example, certain embodiments of system 100 may be a standalone, but potentially networked, computer that processes physical documents completed by customers 108. In this example, the information may be entered by a data entry clerk or scanned by local or remote scanner or other optical device and transmitted to the computer. In another example, the key may have an expiration date/time definition. In this example, the key may be asymmetric and can distribute its key expiration data and time in a public key certificate. After the key expires, a new key may be re-distributed (asymmetric key) or re-generated (symmetric key). Accordingly, the above description of example embodiments does not define or constrain this disclosure. Other changes, substitutions, and alterations are also possible without departing from the spirit and scope of this disclosure.

What is claimed is:

1. A method for verifying a product registration comprising:
receiving a registration form from a customer, the registration form including a first identifier and a second identifier and the second identifier comprising an encrypted value;
comparing a decrypted value of the second identifier to the first identifier; and
verifying the registration form if the decrypted value and the first identifier are substantially similar.

2. The method of claim 1 further comprising:
providing a product to a vendor for sale to the customer; and
providing an encryption key to the vendor, the vendor capable of generating the registration form with the second identifier using the encryption key.

3. The method of claim 2 further comprising providing the encryption key separately from the product via a secure channel.

4. The method of claim 2, the encryption key comprising a public key provided to a plurality of vendors and the method further comprising decrypting the second identifier into the decrypted value using a private key associated with the public key.

5. The method of claim 1 further comprising:
generating the registration form with the second identifier using an encryption key; and
providing a product and the registration form to a vendor for sale to the customer.

6. The method of claim 1, the registration form comprising a physical document associated with a product, the second identifier printed on the form, and the first identifier manually entered.

7. The method of claim 1, the registration form comprising a rebate request form.

8. The method of claim 1, the registration form comprising a warranty registration form.

9. The method of claim 1, the registration form comprising an online activation.

10. A method for providing a product comprising:
providing a product associated with a first identifier to a customer, the first identifier uniquely identifying the product; and
providing a registration form with a second identifier to the customer, the registration form associated with the product and the second identifier comprising an encrypted form of the first identifier.

11. The method of claim 10 further comprising:
receiving the product from a manufacturer;
receiving an encryption key from the manufacturer; and
encrypting the first identifier to generate the second identifier using the encryption key.

12. The method of claim 11 further comprising:
receiving a registration form template from the manufacturer;
generating the registration form for the product based on the template; and
embedding the second identifier in the registration form.

13. The method of claim 11 further comprising receiving the encryption key separately from the product via a secure channel.

14. The method of claim 10, the registration form comprising a physical document packaged with the product.

15. The method of claim 10, the registration form comprising a rebate form.

16. The method of claim 10, the registration form comprising a warranty registration form.

17. The method of claim 10, the registration form comprising a receipt directing the customer to an online activation site.

18. Software comprising computer readable instructions for verifying a product and operable to:
receive a first identifier and a second identifier from a third party, the first identifier associated with a product and the second identifier comprising an encrypted value;
compare a decrypted value of the second identifier to the first identifier; and
verify the product if the decrypted value and the first identifier are substantially similar.

19. The software of claim 18 further operable to provide an encryption key to a vendor, the vendor capable of generating a registration form with the second identifier using the encryption key and selling the product associated with the registration form to the customer.

20. The software of claim 19, the encryption key comprising a public key provided to a plurality of vendors and the software further operable to decrypt the second identifier into the decrypted value using a private key associated with the public key.

21. The software of claim 18 further operable to:
generate a registration form with the second identifier using a secure encryption key; and
provide the registration form to a vendor, the vendor capable of selling the product associated with the registration form to the customer.

22. The software of claim 18, the computer readable instructions at least partially resident on an RFID reader.

23. A system for automatically verifying a product registration comprising:
memory storing at least one decryption key; and
one or more processors operable to:
identify a first identifier and a second identifier from a registration form received from a customer, the second identifier comprising an encrypted value;
decrypt the second identifier into a decrypted value using the decryption key;
compare the decrypted value to the first identifier; and
verify the registration form if the decrypted value and the first identifier are identical.

24. The system of claim 23, the one or more processors further operable to provide an encryption key to a vendor, the vendor capable of generating the registration form with the second identifier using the encryption key and selling a product associated with the registration form to the customer.

25. The system of claim 24, the encryption key comprising a public key provided to a plurality of vendors and the one or more processors further operable to decrypt the second identifier into the decrypted value using a private key associated with the public key.

26. The system of claim 23, the memory further storing a plurality of encryption keys and a plurality of decryption keys and the one or more processors further operable to:
generate the registration form with the second identifier using one of the encryption keys;
provide the registration form to a vendor, the vendor capable of selling a product associated with the registration form to the customer; and
wherein the one or more processors decrypt the second identifier into the decrypted value using the decryption key associated with the particular encryption key.

27. The system of claims 26, each encryption key associated with one of a plurality of vendors.

28. A method for verifying a product comprising:
offering a service to third parties to verify the authenticity of a product;
receiving a first identifier and a second identifier via the service, the first identifier associated with a product and the second identifier comprising an encrypted value;
comparing a decrypted value of the second identifier to the first identifier; and
verifying the product if the decrypted value and the first identifier are substantially similar.
